(19) United States
(12) Patent Application Publication
(10) Pub. No.: US 2014/0000814 A1
(43) Pub. Date: Jan. 2, 2014

(54) Evaporator

(71) Applicant: Osprey Evaporation Technologies, LLC, Kansas City, MO (US)

(72) Inventor: Raymond E. VanKouwenberg, Osprey, FL (US)

(21) Appl. No.: 13/929,457

(22) Filed: Jun. 27, 2013

Related U.S. Application Data
(60) Provisional application No. 61/666,013, filed on Jun. 29, 2012.

(51) Int. Cl. C02F 1/04

(52) U.S. Cl. CPC C02F 1/048
USPC 159/23

(57) ABSTRACT

One evaporator includes a housing defining a generally enclosed interior area and a stepped cascade separating the interior area into an upper chamber and a lower chamber. The stepped cascade includes sequential trays and risers. At least one tray has a hole connecting the upper chamber with the lower chamber, and at least one riser has a hole connecting the upper chamber with the lower chamber. An input device selectively introduces wastewater into the upper chamber, and a heat source selectively introduces heat into the lower chamber sufficient to evaporate water from the wastewater atop and passing through the stepped cascade. A gas exit provides a passage for gas from the interior area to outside the housing.

### RELATED APPLICATIONS

This application claims priority to provisional application 61/666,013 filed Jun. 29, 2012, the disclosure of which is incorporated herein in its entirety by reference.

### BACKGROUND

The prior art includes systems for heating wastewater to evaporate water from a slurry of sludge and water, and to collect the remaining solid particulate matter after the water has been evaporated. Yet such prior art systems are typically complicated and have limited capacity. A need exists for new systems having improved characteristics in these or other areas.

### SUMMARY

The following presents a simplified summary of the invention in order to provide a basic understanding of some aspects of the invention. This summary is not an extensive overview of the invention. It is not intended to identify critical elements of the invention or to delineate the scope of the invention. Its sole purpose is to present some concepts of the invention in a simplified form as a prelude to the more detailed description that is presented elsewhere.

According to one embodiment, an evaporator includes a housing defining a generally enclosed interior area and a stepped cascade separating the interior area into an upper chamber and a lower chamber. The stepped cascade includes sequential trays and risers. At least one tray has a hole connecting the upper chamber with the lower chamber, and at least one riser has a hole connecting the upper chamber with the lower chamber. An input device selectively introduces wastewater into the upper chamber, and a heat source selectively introduces heat into the lower chamber sufficient to evaporate water from the wastewater atop and passing through the stepped cascade. A gas exit provides a passage for gas from the interior area to outside the housing.

According to another embodiment, an evaporator includes a housing, a plurality of downwardly sloping sequential trays and risers, an input device, a heat source, and a gas exit. The housing defines a generally enclosed interior area, and the plurality of downwardly sloping sequential trays and risers divides the interior area into upper and lower chambers. The input device selectively introduces wastewater into the upper chamber for passing across at least a portion of the trays and risers. The heat source selectively introduces heat into the lower chamber sufficient to evaporate water from the wastewater atop the trays and risers. The gas exit provides a passage for gas from the interior area to outside the housing.

### BRIEF DESCRIPTION OF THE DRAWINGS

FIG. 1 is a side view of an evaporator according to one embodiment of the current invention, with a side wall removed for illustration.

FIG. 2 is a section view taken from FIG. 1 as illustrated.

FIG. 3 is an end view of the evaporator of FIG. 1.

FIG. 4 a bottom view of the evaporator of FIG. 1.

### DETAILED DESCRIPTION

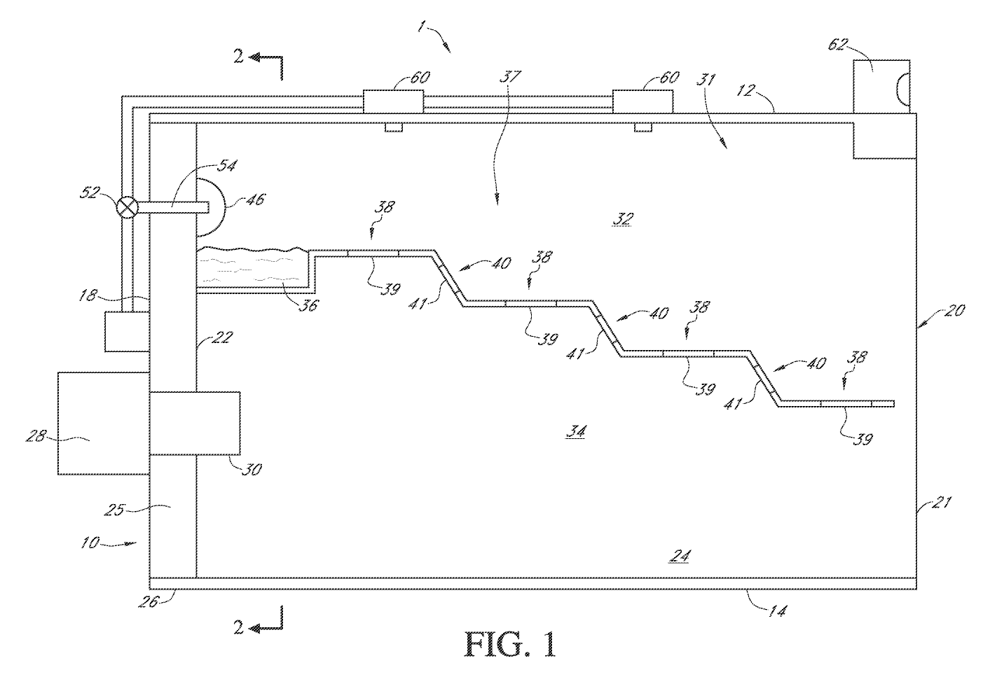

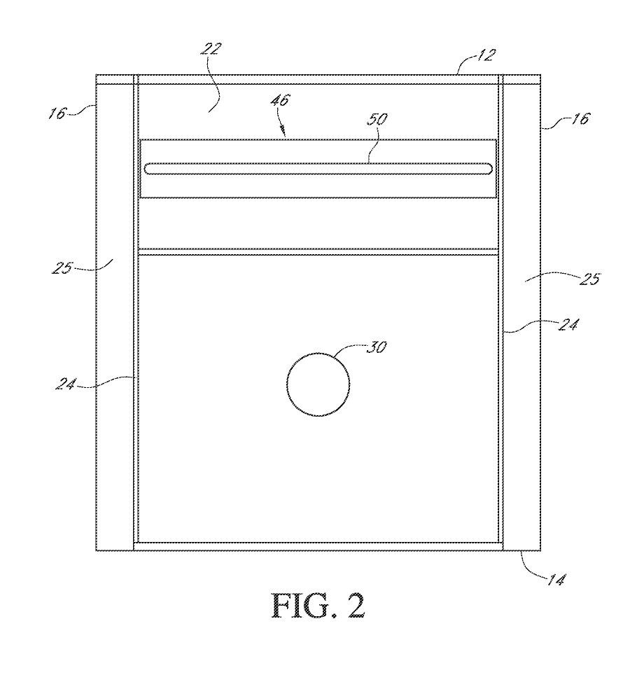

Various evaporators/dryers of the current invention may be simple and economically built, and may efficiently evaporate water, dry solids, and leave oils and other liquids. As shown in FIGS. 1-4, one embodiment 1 of the evaporator/dryer includes a generally rectangular box-like metal housing 10. An effective housing 10 can, for example, be modified from an ocean shipping container which has the approximate dimensions of twenty feet long by eight feet high by eight feet wide, and which has heavy gauge steel walls. Those skilled in the art will appreciate that the housing 10 can be made in many sizes and of various materials, however.

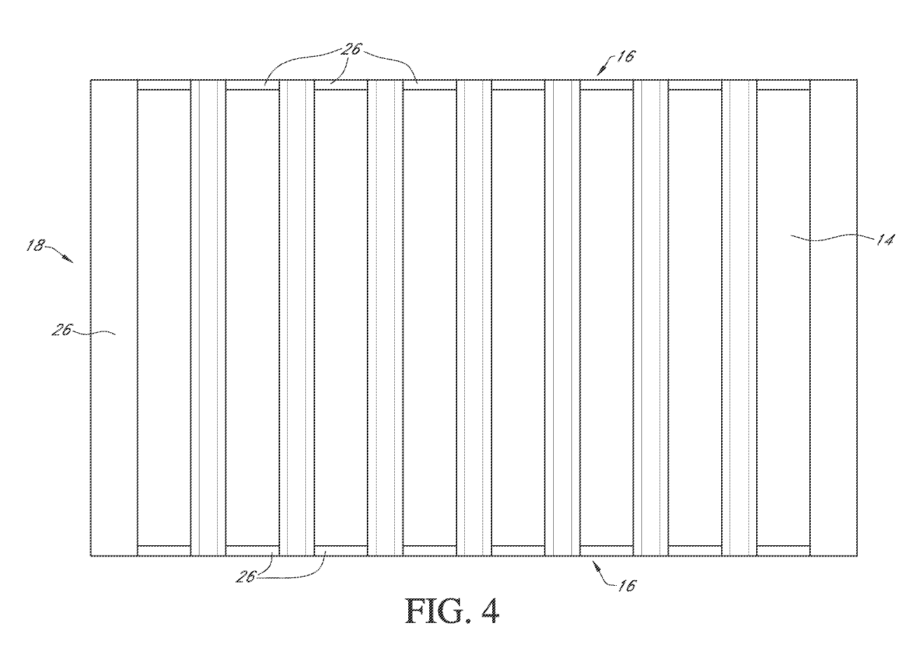

The housing 10 according to one preferred embodiment includes a top 12, a bottom 14, a pair of opposed side walls 16, an end wall 18, and an opposite end 20 with a pair of doors 21. Inner wall liners 22, 24 are spaced apart (e.g., approximately four inches) from the inside of the side walls 16 and the end wall 18. The liners 22, 24 extend from the bottom 14 toward the top 12 of the housing 10, and it may be desirable for the liners 22, 24 to be one unitary liner and to further cover the bottom 14. At least one opening 26 in the bottom 14 of the housing 10 between the outer walls 16, 18 and inner liner 22, 24 may permit exterior air to be drawn into the gap (or “cooling passages”) 25 between the liners 22, 24 and walls 16, 18 to be used to cool (FIG. 4).

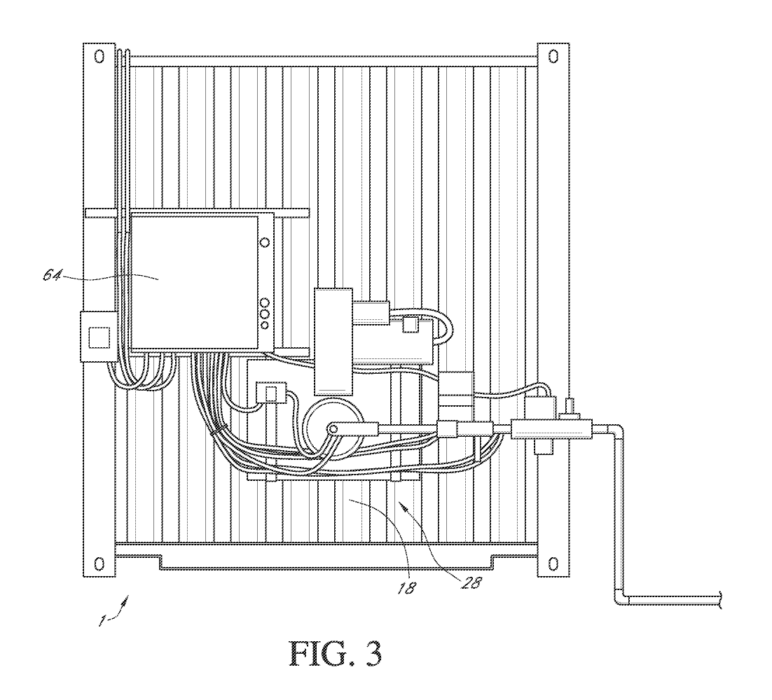

A high power gas burner 28 is mounted to the exterior surface of the end wall 18 as shown in FIGS. 1 and 3. In one preferred embodiment, the burner 28 is gas powered and creates approximately 5,000,000 BTU. Yet a wide range of acceptable fuel sources, burner efficiencies, and burner outputs may be used. The burner 28 may be mounted to the outside wall 18 so that heat is directed through a conduit 30 passing through the outer wall 18 and liner 22 into an interior 31 of the housing 10.

The burner 28 may be mounted to direct the air into the housing 10 under a collector pool 36 and a stepped cascade 37. A flow control 29 may control the rate at which the liquid is introduced into the housing 10 as well as completely close entry of liquid for cleaning or other purposes.

As shown in FIG. 1, a manifold 46 extends generally horizontally across the end liner 22 near the top 12 of the housing 10. The manifold 46 has an elongated slit 50 extending generally horizontally. An intake pump 52 delivers wastewater to a passage 54 which extends generally horizontally through the manifold 46. The wastewater flows out of the slit 50 to cascade downwardly to the collector pool 36 which bridges the side walls 16 beneath the manifold 46. The pool 36 has a bottom formed of a heat conducting material such as galvanized steel, and in some embodiments the pool 36 has a depth of about five inches. Heat from the burner 28 heats the wastewater in the pool 36 before the wastewater cascades onto the stepped cascade 37.

The interior 31 of the housing 10 is divided into an upper chamber 32 and a lower chamber 34 by the collector pool 36 and the stepped cascade 37, which includes an arrangement of grates (or “trays”) 38 and risers 40 which extend in a stepped down arrangement across the interior. The grates 38 extend at a slight angle to horizontal, allowing the wastewater to cascade down the grates 38. Each grate 38 has a plurality of perforations 39 to permit a portion of the wastewater to drop into the lower chamber 34 where heat from the burner 28 vaporizes water from the slurry to leave solid matter. The remaining wastewater flows along the first grate 38 to the first steeply angled riser 40. The risers 40 in the embodiment 1 are angled approximately sixty to seventy degrees to horizontal. And, like the grates 38, the risers 40 may include a plurality of apertures 41. Heat from the burner 28 passes through the apertures 41 to further heat wastewater passing over the risers 40 to assist in the vaporization process.

As shown in FIG. 1, one or more misters 60 may be mounted to the top 12 of the housing 10. The misters 60 may particularly be used to spray water onto the slurry flowing over the stepped cascade 37 to assist in moving the slurry down the stepped cascade 37.

An exhaust fan 62, also shown in FIG. 1, is mounted to the housing top 12 in the embodiment 1. The fan 62 may draw gas from the chambers 32, 34 and from the cooling passages 25 and expel the gas outside of the evaporator 1. A control system 64 (FIG. 3) may be positioned outside the housing 10 and receive data from various sensors monitoring, for example, flow rate of wastewater in various positions along the stepped cascade 37 and temperatures in the chambers 32, 34. To effectively evaporate the wastewater, the control system 64 may control the rate of wastewater introduced into the manifold 46, the operation of the burner 28, the operation of the misters 60, and the operation of the exhaust fan 62.

In using the evaporator 1, the burner 28 is initiated to heat the interior 31 of the housing 10. The air introduced by the burner 28 may be, for example, approximately 2700° F. at the flame's cone. Once the interior 31 of the housing 10 is heated, wastewater is introduced in the upper chamber 32 through the manifold 46 (e.g., at a rate of approximately 240-480 gallons per hour) and to the collector pool 36. Wastewater is allowed to flow across a respective tray 38, over the edge of the tray 38, to and down a respective riser 40, across the subsequent tray 38, and so on. As the wastewater flows down the stepped cascade 37, heat from the lower chamber 34 rises up through the perforations 39, 41 and because of the extreme temperature causes evaporation of the water from the wastewater. In some embodiments, a portion of the wastewater may pass through the perforations 39, 41 and be vaporized in the lower chamber 34; in such embodiments, it may be desirable to control the flow rates and temperatures for this vaporization to occur predominantly (or entirely) before the wastewater reaches a bottom of the lower chamber 34.

As the evaporation process proceeds, the remaining waste is collected on the stepped cascade 37 and because of the heat of the stepped cascade 37 may begin to evaporate and dry into the air. At the same time that the heated air is rising from the lower chamber 34 into the upper chamber 32, cool ambient air may be drawn by the exhaust fan 62 from the exterior through the lower opening 26 into the gap 25 between the housing 10 and the liners 22, 24 to adjacent the housing top 12 where it mixes with the heated air and is carried to the rear of the housing 10 to exit carrying moisture and gases from the burned material.

For most types of wastewater, this process may result in almost complete removal of all sludge either by drying or by evaporation, thus minimizing the need to remove the remaining solid material from the ramp. However, at such times as necessary to clean the stepped cascade 37, the burner 28 is shut down and the housing 10 allowed to cool and introduction of the sludge water is stopped. The doors 21 are then opened and a long rake can be used to rake any particulate matter remaining from the stepped cascade 37 down to the end where it may be removed with a shovel or other implement. Once the particulate matter has been removed, the doors 21 are closed and the device 1 is ready again for use.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention. It will be understood that certain features and subcombinations are of utility and may be employed without reference to other features and subcombinations and are contemplated within the scope of the claims. The specific configurations and contours set forth in the accompanying drawings are illustrative and not limiting.

What is claimed is:

1. An evaporator, comprising:
a housing defining a generally enclosed interior area;
a stepped cascade separating the interior area into an upper chamber and a lower chamber, the stepped cascade comprising sequential trays and risers, at least one said tray having a hole connecting the upper chamber with the lower chamber, at least one said riser having a hole connecting the upper chamber with the lower chamber;
an input device selectively introducing wastewater into the upper chamber;
a heat source selectively introducing heat into the lower chamber sufficient to evaporate water from the wastewater atop and passing through the stepped cascade; and
a gas exit providing a passage for gas from the interior area to outside the housing.

2. The evaporator of claim 1, further comprising a collector pool at an upper end of the stepped cascade, the collector pool being configured to receive the wastewater from the input device before the wastewater reaches the stepped cascade.

3. The evaporator of claim 2, wherein the input device includes a manifold having an elongated slit for passing the wastewater to the collector pool.

4. The evaporator of claim 3, wherein the collector pool has a bottom portion formed of heat-conducting material, and wherein the stepped cascade includes heat-conducting material.

5. The evaporator of claim 4, further comprising:
a liner inside the interior area for restricting the heat introduced by the heat source from passing to a floor and at least one external wall of the housing, at least one cooling passage defined between the liner and the housing; and
a fan in communication with the gas exit to move the gas from the interior area and air from the at least one cooling passage to outside the housing.

6. The evaporator of claim 5, further comprising at least one mister above the stepped cascade for introducing water onto the stepped cascade and thereby assisting in moving the wastewater down the stepped cascade.

7. The evaporator of claim 6, further comprising:
at least one sensor for monitoring a condition inside the interior area; and
a controller in data communication with the at least one sensor; the controller controlling operation of the heat source, the introduction of the wastewater from the input device, the introduction of the water from the at least one mister, and operation of the exhaust fan.

8. The evaporator of claim 7, wherein each said tray and riser is sloped downwardly.

9. The evaporator of claim 8, wherein the heat source is a gas powered burner.

10. The evaporator of claim 9, wherein the housing is constructed of a shipping container having steel walls.

11. The evaporator of claim 10, wherein the heat-conducting material in the bottom portion of the collector pool is galvanized steel.

12. The evaporator of claim 8, wherein the risers are angled between about 60 to 70 degrees to horizontal.

13. The evaporator of claim 1, further comprising:
a collector pool at an upper end of the stepped cascade, the collector pool being configured to receive the wastewater from the input device before the wastewater reaches the stepped cascade, the collector pool having a bottom portion formed of heat-conducting material; and
at least one mister above the stepped cascade for introducing water onto the stepped cascade and thereby assisting in moving the wastewater down the stepped cascade.

14. The evaporator of claim 13, further comprising:
a liner inside the interior area for restricting the heat introduced by the heat source from passing to a floor and at least one external wall of the housing, at least one cooling passage defined between the liner and the housing; and
a fan in communication with the gas exit to move the gas from the interior area and air from the at least one cooling passage to outside the housing.

15. The evaporator of claim 1, further comprising:
a liner inside the interior area for restricting the heat introduced by the heat source from passing to a floor and at least one external wall of the housing, at least one cooling passage defined between the liner and the housing; and
a fan in communication with the gas exit to move the gas from the interior area and air from the at least one cooling passage to outside the housing.

16. The evaporator of claim 15, further comprising:
at least one sensor for monitoring a condition inside the interior area; and
a controller in data communication with the at least one sensor; the controller controlling operation of the heat source, the introduction of the wastewater from the input device, and operation of the exhaust fan.

17. An evaporator, comprising:
a housing defining a generally enclosed interior area;
a plurality of downwardly sloping sequential trays and risers dividing the interior area into upper and lower chambers;
an input device selectively introducing wastewater into the upper chamber for passing across at least a portion of the trays and risers;
a heat source selectively introducing heat into the lower chamber sufficient to evaporate water from the wastewater atop the trays and risers; and
a gas exit providing a passage for gas from the interior area to outside the housing.

18. The evaporator of claim 17, wherein at least one said tray has a hole connecting the upper chamber with the lower chamber.

19. The evaporator of claim 17, wherein at least one said riser has a hole connecting the upper chamber with the lower chamber.
